(19) United States
(12) Patent Application Publication
(10) Pub. No.: US 2026/0211830 A1
(43) Pub. Date: Jul. 23, 2026

(54) HIGH-SPEED COMMUNICATION METHOD AND APPARATUS OF HETEROGENEOUS DEVICE AND HETEROGENEOUS COMMUNICATION SYSTEM

(71) Applicant: IEIT SYSTEMS (BEIJING) CO., LTD., Beijing (CN)

(72) Inventors: Rengang LI, Beijing (CN); Yanwei WANG, Beijing (CN); Cheng HUANG, Beijing (CN); Jiaheng FAN, Beijing (CN); Ran XU, Beijing (CN)

(21) Appl. No.: 19/139,795

(22) PCT Filed: Dec. 15, 2023
(86) PCT No.: PCT/CN2023/139252

§ 371 Date: Jun. 16, 2025

(30) Foreign Application Priority Data
Sep. 4, 2023 (CN) 202311127077.0

(51) Int. Cl. G06F 13/42

(52) U.S. Cl. CPC G06F 13/42; G06F 2213/16

(57) ABSTRACT

The present application relates to the field of communications, and provides a high-speed communication method and apparatus of a heterogeneous device and a heterogeneous communication system. The method comprises: a high-speed interconnection remote virtualization processor receives a high-speed interconnection operation; the high-speed interconnection remote virtualization processor converts the high-speed interconnection operation to a register operation and a memory data migration operation on a heterogeneous accelerator of a target heterogeneous device; the high-speed interconnection remote virtualization processor converts the register operation and the memory data migration operation to a communication request; and the high-speed interconnection remote virtualization processor communicates with the target heterogeneous device by means of the communication request, so as to execute the register operation and the memory data migration operation. The present application achieves the local mapping of the state of a remote heterogeneous device without relying on software and without damaging the performance of the communication device, reducing the communication delay and the occupation of computing resources of the communication device, guaranteeing the communication performance and the operation performance of local application services.

### CROSS-REFERENCE TO RELATED APPLICATION

The present application claims priority to Chinese patent application No. 202311127077.0, entitled “HIGH-SPEED COMMUNICATION METHOD AND APPARATUS OF HETEROGENEOUS DEVICE AND HETEROGENEOUS COMMUNICATION SYSTEM”, filed on Sep. 4, 2023 before the China National Intellectual Property Administration, which is incorporated herein in its entirety by reference.

### TECHNICAL FIELD

This application relates to the communications technology, and in particular to a high-speed communication method and apparatus for heterogeneous devices, a heterogeneous communication system, a non-volatile readable storage medium, and a communication device.

### BACKGROUND

Currently, accessing remote heterogeneous devices from a host relies on communication software and virtual device drivers, both of which are software-based. This significantly impairs performance. Moreover, it is necessary to be converted into multiple application software and virtual device driver operations, which severely increases processing latency and occupies substantial computational resources, thereby affecting the operation of other application services.

### SUMMARY

The objective of the present application is to provide a high-speed communication method and apparatus for heterogeneous devices, a heterogeneous communication system, a non-volatile readable storage medium, and a communication device.

To address the aforementioned technical issues, the present application provides a high-speed communication method for heterogeneous devices, applied to a communication device including a high-speed interconnection remote virtualization processor, including:
receiving, by the high-speed interconnection remote virtualization processor, a high-speed interconnection operation;
converting, by the high-speed interconnection remote virtualization processor, the high-speed interconnection operation into register operations and memory data movement operations on a heterogeneous accelerator of a target heterogeneous device;
converting, by the high-speed interconnection remote virtualization processor, the register operations and the memory data movement operations into a communication request; and
communicating, by the high-speed interconnection remote virtualization processor, with the target heterogeneous device through the communication request to perform the register operations and the memory data movement operations.

In some embodiments, before receiving, by the high-speed interconnection remote virtualization processor, the high-speed interconnection operation, the method further includes:
establishing a connection between the high-speed interconnection remote virtualization processor and the target heterogeneous device through a high-speed communication link in response to the target heterogeneous device being started.

In some embodiments, after the establishing a connection between the high-speed interconnection remote virtualization processor and the target heterogeneous device through a high-speed communication link in response to the target heterogeneous device being started, the method further includes:
allocating, by the high-speed interconnection remote virtualization processor, context information corresponding to the target heterogeneous device.

In some embodiments, the allocating, by the high-speed interconnection remote virtualization processor, context information corresponding to the target heterogeneous device includes:
allocating, by the high-speed interconnection remote virtualization processor, memory function data and register-related data corresponding to the target heterogeneous device.

In some embodiments, after the allocating, by the high-speed interconnection remote virtualization processor, context information corresponding to the target heterogeneous device, the method further includes:
issuing, by a central processor on a host, the high-speed interconnection operation to the high-speed interconnection remote virtualization processor through a high-speed interconnection module.

In some embodiments, the converting, by the high-speed interconnection remote virtualization processor, the high-speed interconnection operation into register operations and memory data movement operations on the heterogeneous accelerator of the target heterogeneous device, includes:
converting, by the high-speed interconnection remote virtualization processor, the high-speed interconnection operation into the register operations and the memory data movement operations on the heterogeneous accelerator of the target heterogeneous device through a high-speed interconnection operation mapping processing unit and a microcode processing unit.

In some embodiments, the high-speed communication method further includes:
setting, by the microcode processing unit, corresponding configuration information according to register information of the target heterogeneous device, wherein the configuration information is used for communication adaptation with the target heterogeneous device.

In some embodiments, the high-speed communication method further includes:
virtualizing operation context of the target heterogeneous device to the high-speed interconnection remote virtualization processor located locally.

In some embodiments, after receiving, by the high-speed interconnection remote virtualization processor, the high-speed interconnection operation instruction, the method further includes:
splitting, by the high-speed interconnection remote virtualization processor, the high-speed interconnection operation instruction into multiple high-performance communication instructions.

In some embodiments, when the high-speed interconnection operation instruction comprises a read instruction, a write instruction, and a cache instruction, after splitting, by the high-speed interconnection remote virtualization processor, the high-speed interconnection operation instruction into multiple high-performance communication instructions, the method further includes:
in response to determining that the high-speed interconnection operation instruction comprises the read instruction, receiving the read instruction and allocating a corresponding read request memory for the read instruction; reading memory data on the heterogeneous device according to the read instruction and responding to the read instruction based on the memory data; releasing the read request memory;
in response to determining that the high-speed interconnection operation instruction comprises the write instruction, receiving the write instruction and allocating a corresponding write request memory; writing data into the write request memory, and writing the data into the memory of the heterogeneous device through a write operation; responding to the read request and releasing the read request memory by the high-speed interconnection remote virtualization processor;
in response to determining that the high-speed interconnection operation instruction comprises the cache instruction, receiving the cache instruction and allocating a corresponding cache request memory; writing cache data into the cache request memory; writing the cache data in the cache request memory into the memory of the heterogeneous device through a write operation, and updating the cache status of the heterogeneous device; reading the cache data into the memory of the high-speed interconnection remote virtualization processor through a read operation; releasing, by the high-speed interconnection remote virtualization processor, the cache request memory and synchronizing the virtualized cache status.

In some embodiments, after allocating, by the high-speed interconnection remote virtualization processor, context information corresponding to the target heterogeneous device, the method further includes:
determining an accessible memory address range of the target heterogeneous device based on the context information.

In some embodiments, the high-speed communication method further includes:
updating, by the high-speed interconnection remote virtualization processor, the context information on the high-speed interconnection remote virtualization processor based on device status of the target heterogeneous device.

In some embodiments, the high-speed communication method further includes:
performing, by the high-speed interconnection remote virtualization processor, input/output data transmission with the target heterogeneous device using an input/output protocol based on high-speed interconnection protocols.

In some embodiments, the high-speed communication method further includes:
accessing, by the high-speed interconnection remote virtualization processor, a memory of a central processor using a system memory protocol based on high-speed interconnection protocols.

In some embodiments, the high-speed communication method further includes:
sharing, by the high-speed interconnection remote virtualization processor, the central processor's memory and the graphics card's memory using a system memory protocol based on high-speed interconnection protocols.

The present application further provides a heterogeneous communication system, including:
a host, a switch with high-speed communication capabilities, and at least one heterogeneous device connected in sequence;
the host includes a central processor, a high-speed interconnection module, and a high-speed interconnection remote virtualization module;
the host is configured to perform the following operations through the high-speed interconnection remote virtualization processor located on the host:
converting a high-speed interconnection operation into register operations and memory data movement operations on a heterogeneous accelerator of the heterogeneous device; converting the register operations and the memory data movement operations into a communication request; communicating with the heterogeneous device through the communication request to perform the register operations and the memory data movement operations.

In some embodiments, the high-speed interconnection remote virtualization processor includes:
a microcode processing unit, configured to set corresponding configuration information based on register information of a target heterogeneous device, wherein the configuration information is used for communication adaptation with the target heterogeneous device.

In some embodiments, the high-speed interconnection remote virtualization processor includes:
a context information management unit, configured to allocate context information corresponding to the target heterogeneous device.

In some embodiments, the context information management unit is further configured to update the context information on the high-speed interconnection remote virtualization processor based on device status of the target heterogeneous device.

The present application further provides a high-speed communication apparatus for heterogeneous devices, applied to a communication device including a high-speed interconnection remote virtualization processor, the high-speed communication apparatus includes:
a receiving module, configured to receive a high-speed interconnection operation;
an operation conversion module, configured to convert the high-speed interconnection operation into register operations and memory data movement operations on a heterogeneous accelerator of a target heterogeneous device;
a request conversion module, configured to convert the register operations and the memory data movement operations into a communication request; and
a communication module, configured to communicate with the target heterogeneous device through the communication request to perform the register operations and the memory data movement operations.

In some embodiments, the high-speed communication apparatus also includes:
an establishment module, configured to establish a connection between the high-speed interconnection remote virtualization processor and the target remote heterogeneous device through a high-speed communication link after the target heterogeneous device is started.

In some embodiments, the high-speed communication apparatus also includes:
an allocation module, configured to allocate context information corresponding to the target remote heterogeneous device after the target heterogeneous device is started and the connection between the high-speed interconnection remote virtualization processor and the target remote heterogeneous device is established through a high-speed communication link.

In some embodiments, the allocation module includes:
an allocation unit, configured to allocate memory function data and register-related data corresponding to the target remote heterogeneous device.

In some embodiments, the high-speed communication apparatus also includes:
a connection module, configured to issue the high-speed interconnection operation to the high-speed interconnection remote virtualization processor through the high-speed interconnection module after allocating the context information corresponding to the target remote heterogeneous device.

In some embodiments, the operation conversion module includes:
a conversion unit, configured to convert the high-speed interconnection operation into the register operations and the memory data movement operations on the heterogeneous accelerator of the target heterogeneous device through the high-speed interconnection operation mapping processing unit and the microcode processing unit.

In some embodiments, the high-speed communication apparatus also includes:
a configuration information setting module, configured to set corresponding configuration information through the microcode processing unit based on the register information of the target remote heterogeneous device; the configuration information is used for communication adaptation with the target remote heterogeneous device.

In some embodiments, the high-speed communication apparatus also includes:
a virtualization module, configured to virtualize the operation context of the target remote heterogeneous device to the local high-speed interconnection remote virtualization processor.

In some embodiments, the high-speed communication apparatus also includes:
a splitting module, configured to split the high-speed interconnection operation instruction into multiple high-performance communication instructions when the high-speed interconnection remote virtualization processor receives the high-speed interconnection operation instruction.

In some embodiments, the high-speed communication apparatus also includes:
a read processing module, configured to, in response to the high-speed interconnection operation instruction including a read instruction, receive the read instruction and allocate corresponding read request memory; read the memory data on the heterogeneous device according to the read instruction and respond to the read instruction based on the memory data; release the read request memory;
a write processing module, configured to, in response to the high-speed interconnection operation instruction including a write instruction, receive the write instruction and allocate corresponding write request memory; write data to the write request memory and write the data to the memory on the heterogeneous device through a write operation; the high-speed interconnection remote virtualization processor responds to the read request and releases the read request memory;
a cache processing module, configured to, in response to the high-speed interconnection operation instruction including a cache instruction, receive the cache instruction and allocate corresponding cache request memory write cache data to the cache request memory.

The cache data in the cache request memory is written to the memory on the heterogeneous device through the write operation, and the cache status of the heterogeneous device is updated; the cache data is read to the memory on the high-speed interconnection remote virtualization processor through the read operation; the high-speed interconnection remote virtualization processor then releases the cache request memory and synchronizes the virtualized cache status.

In some embodiments, the high-speed communication apparatus also includes:
a determination module, configured to determine the accessible memory address range of the target remote heterogeneous device based on the context information after the context information corresponding to the target remote heterogeneous device being allocated.

In some embodiments, the high-speed communication apparatus also includes:
an update module, configured to update the context information on the high-speed interconnection remote virtualization processor based on the device status of the target heterogeneous device.

In some embodiments, the high-speed communication apparatus also includes:
a transmission module, configured to perform input-output data transmission with the target heterogeneous device using the input-output protocol based on the high-speed interconnection protocol.

In some embodiments, the high-speed communication apparatus also includes:
an access module, configured to access the CPU's memory using the system memory protocol based on the high-speed interconnection protocol.

In some embodiments, the high-speed communication apparatus also includes:
a sharing module, configured to achieve memory sharing between the CPU and the graphics card using the system memory protocol based on the high-speed interconnection protocol.

The present application further provides a non-volatile readable storage medium storing a computer program that, when executed by a processor, implements steps of the high-speed communication method for heterogeneous devices described above.

The present application further provides a communication device, comprising a memory and a processor, wherein the memory is stored with a computer program that, when called by the processor, implements steps of the high-speed communication method for heterogeneous devices described above.

### BRIEF DESCRIPTION OF THE DRAWINGS

In order to more clearly illustrate the technical solutions in the embodiments of the present application or in the related art, the accompanying drawings required for the description of the embodiments or the related art will be briefly introduced below. Apparently, the accompanying drawings in the following description only illustrate embodiments of the present application. For those skilled in the art, other accompanying drawings can be obtained based on the provided drawings without creative effort.

FIG. 1 is a schematic diagram illustrating an access structure between a host and remote heterogeneous devices provided by an embodiment of the present application;

FIG. 2 is a flowchart of a high-speed communication method for heterogeneous devices provided by an embodiment of the present application;

FIG. 3 is a schematic diagram of functional hierarchy offloading for high-speed communication of heterogeneous devices provided by an embodiment of the present application;

FIG. 4 is a schematic diagram illustrating network logic for high-speed communication for heterogeneous devices provided by an embodiment of the present application;

FIG. 5 is a schematic structural diagram of a mixed networking of heterogeneous devices provided by an embodiment of the present application;

FIG. 6 is a schematic structural diagram of a high-speed communication apparatus for heterogeneous devices provided by an embodiment of the present application; and

FIG. 7 is a schematic structural diagram of a communication device provided by an embodiment of the present application.

### DETAILED DESCRIPTION OF THE EMBODIMENTS

To make the objectives, technical solutions, and advantages of the embodiments of the present application clearer, the technical solutions in the embodiments of the present application will be described in detail with reference to the accompanying drawings. Apparently, the described embodiments are part of the embodiments of the present application, not all of them. All other embodiments obtained, based on the embodiments of the present application, by those skilled in the art without creative effort shall fall within the protection scope of the present application.

Compute express link (CXL, which is a new interconnection technology standard that enables high-speed and efficient connections between central processing units (CPUs) and GPUS (graphics processing units), FPGAs (Field Programmable Gate Arrays), or other accelerators, meeting the requirements of high-performance heterogeneous computing while maintaining consistency between the CPU memory space and the connected device memory) can be used to access local heterogeneous devices. CXL enables high-performance, low CPU-occupancy access to heterogeneous accelerators. However, accessing remote heterogeneous devices is more challenging because CXL requires hardware support to meet performance requirements (similar to 5G, where a 5G-enabled phone is required to support 5G). Heterogeneous accelerators typically do not support remote access via CXL.

To virtualize remote heterogeneous devices, it is necessary to connect to remote heterogeneous accelerators through communication software APIs (e.g., RDMA verbs, sockets), and then send instructions via communication software to access the heterogeneous devices. Then, the operations on the remote heterogeneous devices are encapsulated in drivers to complete the virtualization of remote heterogeneous devices. Such method results in low access efficiency.

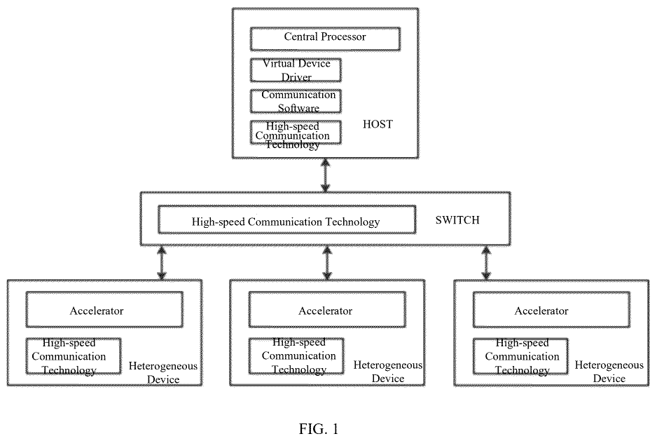

Referring to FIG. 1, FIG. 1 is a schematic diagram illustrating an access structure between a host and remote heterogeneous devices provided by an embodiment of the present application. As can be seen from FIG. 1, access to remote heterogeneous devices by the host relies on communication software and virtual device drivers. The basic access operations of the host's central processing unit (CPU) to remote heterogeneous devices need to be converted into multiple application software and virtual device driver operations, which significantly impairs performance. Additionally, the host needs to distinguish between local and remote heterogeneous accelerators, and handle different devices through different logic. This is because operations on remote heterogeneous devices need to be converted into multiple application software and virtual device driver operations, which significantly increases the complexity of logical processing. Remote accelerators and the CPU are not within the same host, while local accelerators and the CPU are within the same host. When devices are registered with the operating system, those connected via local PCIe are identified as local heterogeneous accelerators during PCIe device registration. Remote devices are identified as remote heterogeneous accelerators when registered through virtualization drivers.

Thus, the access to remote heterogeneous devices by the host relies on communication software and virtual device drivers, which significantly impairs performance. Additionally, application software and virtual device drivers, being software, occupy a large amount of CPU computational resources, preventing valuable CPU resources from being used for application business processing. Furthermore, the basic access operations of the host's CPU on remote heterogeneous devices need to be converted into multiple application software and virtual device driver operations, severely increasing processing latency. Moreover, the host needs to distinguish between local and remote heterogeneous accelerators, which increases the complexity of logical processing.

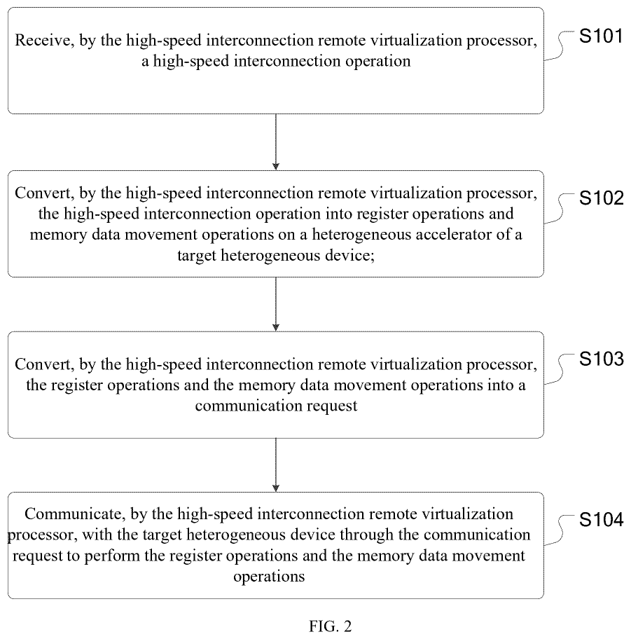

To address the above technical issues, referring to FIG. 2, FIG. 2 is a flowchart of a high-speed communication method for heterogeneous devices provided by an embodiment of the present application. The method includes steps described below.

At S101, a high-speed interconnection operation is received by a high-speed interconnection remote virtualization processor.

The high-speed interconnection remote virtualization module processor is a chip or accelerator card on the host or local device, and is mainly used for splitting a high-speed interconnection operation request into multiple other high-performance communication technology instructions (e.g., InfiniBand (IB) instructions), and maintaining the relevant context, such as cache information, of the high-speed interconnection operations. The high-speed interconnection operation in this step refers to CXL operations.

This embodiment assumes that a connection between the high-speed interconnection remote virtualization processor and a target heterogeneous device has been established before executing this step. Of course, the essence of this connection process is the connection between the host or local device containing the high-speed interconnection remote virtualization processor and the target heterogeneous device. Specifically, the target heterogeneous device can be a remote heterogeneous device, thereby enabling remote communication.

Additionally, after the target heterogeneous device is started and the connection between the high-speed interconnection remote virtualization processor and the target heterogeneous device is established through a high-speed communication link, the high-speed interconnection remote virtualization processor can allocate the context information corresponding to the target heterogeneous device. Specifically, the high-speed interconnection remote virtualization processor can allocate memory function data and register-related data corresponding to the target heterogeneous device. Since CXL is a set of functional modules for accessing memory data on heterogeneous acceleration devices, divided into three major sub-protocols, CXL.mem, CXL.cache, and CXL.io. CXL is a hardware-based application for accessing heterogeneous device memory. Therefore, CXL requests cannot fully correspond to communication functions and will inevitably involve functions related to memory, cache, data synchronization, etc. These functions will be converted into a series of data and register read/write and modification operations based on the internal implementation of the heterogeneous device. Thus, if the high-speed interconnection remote virtualization processor receives a high-speed interconnection operation instruction, it can split the high-speed interconnection operation instruction into multiple high-performance communication instructions. Specifically, the high-speed interconnection remote virtualization processor can split the high-speed interconnection operation instruction into multiple high-performance communication instructions based on at least one of memory configuration, cache configuration, register configuration, and data synchronization settings.

Currently, remote heterogeneous accelerators can only be connected through communication software APIs (e.g., RDMA verbs, sockets), and instructions are sent via communication software to access the heterogeneous devices. The operations on remote heterogeneous devices are encapsulated in drivers to complete the virtualization of remote heterogeneous devices. However, this process not only fails to achieve cache coherence but also requires modifying application software logic at the upper layer to achieve cache coherence. Therefore, existing technologies do not support cache-related instructions, which results in poor access performance to remote heterogeneous devices.

Taking a current read instruction as an example, it includes the following process:
1. The host application calls the system device API;
2. The host system calls the virtualized device driver;
3. The host virtualized device driver calls the high-speed communication API;
4. Data is read from the memory on the heterogeneous device through IB RDMA verbs read operations;
5. After the read is completed, the software stack returns step by step.

In the embodiments of the present application, when splitting the high-speed interconnection operation instruction, it can be split into read instructions, write instructions, and cache instructions. These three types of instructions can usually be obtained together or in any combination of one or two types.

The processing after splitting is described below by using read instructions, write instructions, and cache instructions as examples.

When the high-speed interconnection operation instruction includes a read instruction, the following steps may be included:
receiving the read instruction, and allocating a corresponding read request memory for the read instruction;
reading the memory data on the heterogeneous device according to the read instruction and responding to the read instruction based on the memory data; and
releasing the read request memory.

It can be seen that in this embodiment, for the read instruction in the high-speed interconnection operation instruction, it only needs to allocate a corresponding memory to execute the read instruction, and is not necessary to call various APIs and virtualized device drivers, which avoids the invocation of many APIs and complex operations, greatly improves access performance.

When the high-speed interconnection operation instruction includes a write instruction, the following steps may be included:
receiving the write instruction, and allocating a corresponding write request memory;
writing data to the write request memory, and writing the data to the memory on the heterogeneous device through a write operation; and
responding to the read request by the high-speed interconnection remote virtualization processor, and releasing the read request memory.

When the high-speed interconnection operation instruction includes a cache instruction, the following steps may be included:
receiving the cache instruction, and allocating a corresponding cache request memory;
writing cache data to the cache request memory;
writing the cache data in the cache request memory to the memory on the heterogeneous device through a write operation, and updating the cache status of the heterogeneous device;
reading the cache data to the memory on the high-speed interconnection remote virtualization processor through a read operation;
then releasing, by the high-speed interconnection remote virtualization processor, the cache request memory, and synchronizing the virtualized cache status.

Context information is the intermediate data related to CXL functions, such as the accessible memory address range of the remote heterogeneous device. Therefore, the accessible memory address range of the target heterogeneous device can be determined based on the context information. At the same time, the operation context of the target heterogeneous device can be virtualized to the high-speed interconnection remote virtualization processor located locally. It should be noted that this context information is not exposed unnecessarily, and the high-speed interconnection remote virtualization processor can update the context information based on the device status of the target heterogeneous device.

At S102, the high-speed interconnection remote virtualization processor converts the high-speed interconnection operation into register operations and memory data movement operations on the heterogeneous accelerator of the target heterogeneous device.

At S103, the high-speed interconnection remote virtualization processor converts the register operations and memory data movement operations into a communication request.

At S104, the high-speed interconnection remote virtualization processor communicates with the target heterogeneous device through the communication request to execute the register operations and memory data movement operations.

When executing step S102, the high-speed interconnection operation can be converted into register operations and memory data movement operations on the heterogeneous accelerator of the target heterogeneous device with the help of the high-speed interconnection operation mapping processing unit and the microcode processing unit. The microcode processing unit can also set corresponding configuration information based on the register information of the target heterogeneous device; the configuration information is used for communication adaptation with the target heterogeneous device. Specifically, for the differences in instructions and registers of different remote heterogeneous accelerator cards, the high-speed interconnection remote virtualization module processor is equipped with the microcode processing unit, providing simple configurability to adapt to the implementation differences of different heterogeneous accelerator cards.

After the register operations and memory data movement operations are obtained, they can be integrated into a communication request, and communication with the target heterogeneous device can be performed through the native high-speed communication protocol to execute the register operations and memory data movement operations.

Local communication devices can indistinguishably access heterogeneous accelerators at both local and remote ends through the high-speed interconnection remote virtualization processor. Remote accelerators only need to support conventional high-performance communication standards without additional hardware requirements. The high-speed interconnection operation is converted into register operations and memory data movement operations on the heterogeneous accelerator, achieving the conversion of high-speed interconnection operations to traditional high-speed communication methods. The operation context of the remote heterogeneous device is virtualized to the local high-speed interconnection remote virtualization module processor, realizing the mapping of the remote heterogeneous device state to the local environment. The high-speed interconnection remote virtualization module processor can perform related operations locally based on the remote state, that is, the CPU in the local communication device can access the high-speed interconnection remote virtualization module processor in the same way it accesses local heterogeneous accelerators, without relying on software, causing no performance damage to the communication device, reducing communication latency and the computational resource occupation of the communication device, ensuring communication performance and local application business operation performance.

Based on the above embodiments, after the high-speed interconnection remote virtualization processor allocates the context information corresponding to the target heterogeneous device, the CPU on the host can issue the high-speed interconnection operation to the high-speed interconnection remote virtualization processor through the high-speed interconnection module.

Taking the InfiniBand instruction as an example, if it is applied to a remote heterogeneous device, a corresponding complete execution process can be as follows:
(1) The remote heterogeneous device starts and connects to the high-speed interconnection remote virtualization module processor through high-speed communication technology.
(2) The remote heterogeneous device registers its own information and allocates corresponding context information on the high-speed interconnection remote virtualization module processor.
(3) The host CPU issues the high-speed interconnection operation to the high-speed interconnection remote virtualization module processor through the high-speed interconnection interface.
(4) The high-speed interconnection remote virtualization module processor receives the high-speed interconnection operation.
(5) The high-speed interconnection remote virtualization module processor converts the high-speed interconnection operation into register operations and memory data movement operations on the heterogeneous accelerator through the high-speed interconnection operation mapping processing unit and the remote heterogeneous device microcode processing unit.
(6) The high-speed interconnection remote virtualization module processor updates the context information of the remote heterogeneous device on the high-speed interconnection remote virtualization module processor based on the status of the heterogeneous device.
(7) The high-speed interconnection remote virtualization module processor converts the register operations and memory data movement operations into IB communication request.
(8) The high-speed interconnection remote virtualization module processor communicates with the heterogeneous device through the InfiniBand protocol to complete the register operations and memory data movement operations.
(9) The high-speed interconnection operation is completed.

In step (1), the remote heterogeneous device connects to the high-speed interconnection remote virtualization module processor of the host through high-speed communication technology. Next, the remote heterogeneous device needs to register, so that the high-speed interconnection remote virtualization module processor can identify it as a local or remote device. During registration, the high-speed interconnection remote virtualization module processor allocates context information for the remote heterogeneous device. Subsequently, the remote heterogeneous device issues the high-speed interconnection operation, then the host CPU issues the high-speed interconnection operation to the high-speed interconnection remote virtualization module processor, virtualizes the operation context of the remote heterogeneous device to the local high-speed interconnection remote virtualization module processor, realizing the mapping of the remote heterogeneous device state to the local environment. In this way, the high-speed interconnection remote virtualization module processor can perform related operations locally based on the state of the remote heterogeneous device. The subsequent process can refer to the above and will not be repeated here.

Referring to FIG. 3, FIG. 3 is a schematic diagram of the functional hierarchy offloading for high-speed communication of heterogeneous devices provided by an embodiment of the present application. A Field Programmable Gate Array (FPGA) is used as an example of the heterogeneous device. The high-speed interconnection remote virtualization processor is displayed independently to more clearly demonstrate its functional role in the communication process using the InfiniBand protocol. However, in practical applications, the high-speed interconnection remote virtualization processor should be located on the host. The high-speed interconnection remote virtualization processor may include a high-speed interconnection context management unit for allocating or updating the context information of remote heterogeneous devices. The high-speed interconnection operation mapping processing unit is based on the InfiniBand protocol, and both the high-speed interconnection operation mapping processing unit and the microcode processing unit are used to perform the conversion of high-speed interconnection operations to obtain register operations and memory data movement operations, which are then communicated via the wireless bandwidth interface and transmitted to the heterogeneous device.

CXL is an open standard for high-speed CPU-to-device and CPU-to-memory connections, designed specifically for high-performance data center computers. CXL is an open interconnect standard for CPUs and other devices, not only supporting IO device interconnection but also enabling memory and cache interconnection between devices. This interconnect standard supports three protocols, that is, CXL.io, CXL.memory and CXL.Cache.

CXL.io is functionally equivalent to the PCIe 5.0 protocol, served as IO transmission between devices.

CXL.memory primarily enables memory sharing between the CPU and other devices. For example, if the CPU is connected to a graphics card via CXL, this protocol allows the CPU to access the graphics card's video memory, and the graphics card can also access the CPU's memory. The graphics card accesses the CPU's memory through the CXL.Cache protocol.

CXL.Cache can be understood as designed for more specific applications, allowing accelerators to efficiently access the cache of the main CPU's memory to optimize performance.

Accordingly, the high-speed interconnection remote virtualization processor can use the input-output protocol based on the high-speed interconnection protocol to perform input-output data transmission with the target heterogeneous device. At the same time, the high-speed interconnection remote virtualization processor can also use the system memory protocol based on the high-speed interconnection protocol to access the CPU's memory and can use the system memory protocol based on the high-speed interconnection protocol to achieve memory sharing between the CPU and the graphics card.

In summary, it can be seen that in the embodiments of the present application, the host CPU accesses remote heterogeneous accelerators through the high-speed interconnection remote virtualization module technology, and the CPU accesses the high-speed interconnection remote virtualization module processor in the same way it accesses local heterogeneous accelerators. The entire access process is offloaded by the high-speed interconnection remote virtualization module processor. The present application can also convert high-speed interconnection operations into register operations and memory data movement operations of heterogeneous accelerators, achieving the conversion of high-speed interconnection operations to native high-speed communication methods, while providing certain programmability and configurability to adapt to differences in different remote heterogeneous devices.

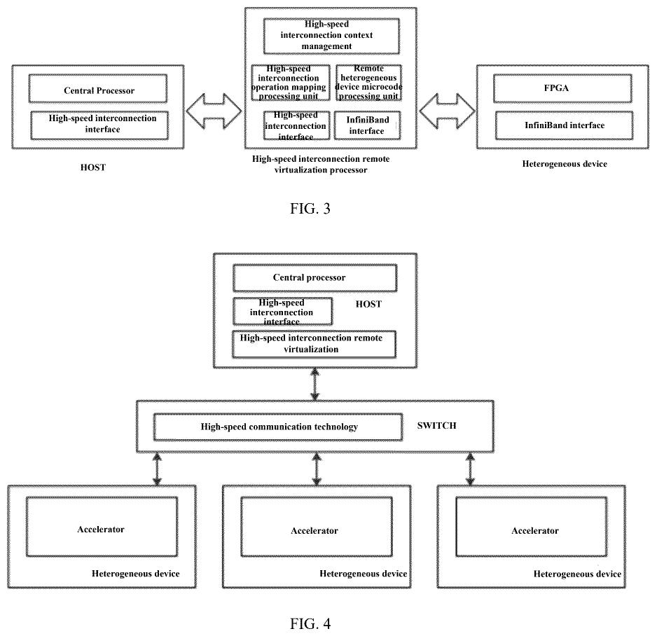

Referring to FIG. 4, FIG. 4 is a schematic diagram of the network logic for high-speed communication of heterogeneous devices provided by an embodiment of the present application. The present application further provides a heterogeneous communication system, including: a host, a switch with high-speed communication capabilities, and at least one heterogeneous device connected in sequence.

The host includes a CPU, a high-speed interconnection module, and a high-speed interconnection remote virtualization processor.

The host is configured to perform the following operations using the high-speed interconnection remote virtualization processor located on the host:
converting the high-speed interconnection operation into register operations and memory data movement operations on the heterogeneous accelerator of the heterogeneous device; converting register operations and memory data movement operations into a communication request; communicating with the heterogeneous device through the communication request to execute register operations and memory data movement operations.

The switch only needs to support basic high-speed communication, mainly requiring hardware optimization of the host and heterogeneous devices to support CXL operations.

In a feasible embodiment, the high-speed interconnection remote virtualization processor includes:
a microcode processing unit, configured to set corresponding configuration information based on the register information of the target heterogeneous device; the configuration information is used for communication adaptation with the target heterogeneous device.

In other feasible embodiments, the high-speed interconnection remote virtualization processor may include a context information management unit, configured to allocate context information corresponding to the target heterogeneous device.

In a feasible embodiment, the context information management unit is also configured to update the context information on the high-speed interconnection remote virtualization processor based on the device status of the target heterogeneous device.

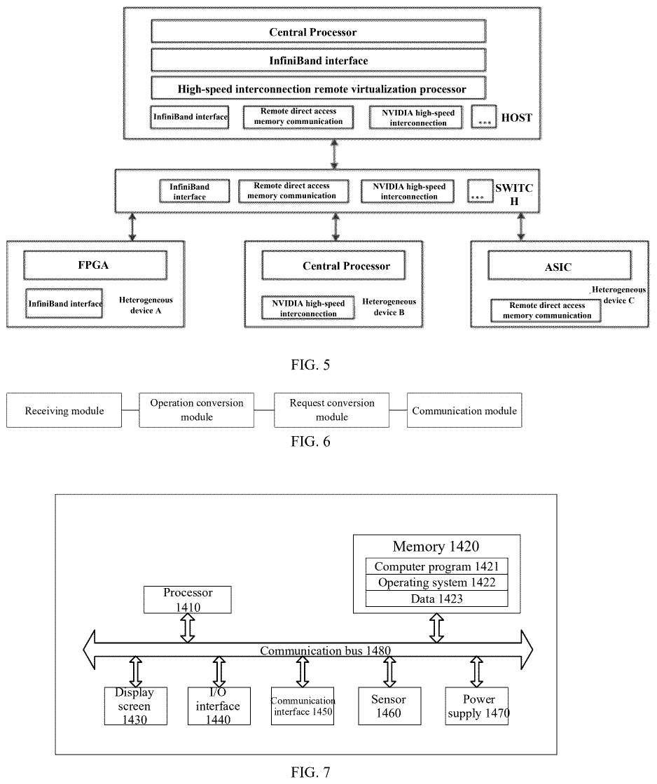

Referring to FIG. 5, FIG. 5 is a schematic structural diagram illustrating a mixed networking of heterogeneous devices provided by an embodiment of the present application. In addition to the InfiniBand protocol, the high-speed communication method for heterogeneous devices provided by the present application can also be applied to all heterogeneous accelerators, including but not limited to RoCE (RDMA over Converged Ethernet), NVLink (NVIDIA high-speed interconnection protocol), and various manufacturers' private protocols. Furthermore, it can achieve mixed networking using different communication technologies and different types of accelerators, further enhancing system compatibility and enabling mixed networking of more devices with different standards. It can be seen that the present application can achieve mixed networking using different communication technologies and different types of accelerators, further enhancing system compatibility.

Referring to FIG. 6, the present application also provides a high-speed communication apparatus for heterogeneous devices, applied to a communication device with a high-speed interconnection remote virtualization processor, including:
a receiving module, configured to receive a high-speed interconnection operation;
an operation conversion module, configured to convert high-speed interconnection operation into register operations and memory data movement operations on a heterogeneous accelerator of a target heterogeneous device;
a request conversion module, configured to convert the register operations and the memory data movement operations into a communication request; and
a communication module, configured to communicate with the target heterogeneous device through the communication request to execute the register operations and the memory data movement operations.

The high-speed communication apparatus for heterogeneous devices provided in this embodiment allows local communication devices to access both local and remote heterogeneous accelerators indistinguishably through the high-speed interconnection remote virtualization processor. Remote accelerators only need to support conventional high-performance communication standards without additional hardware requirements. The high-speed interconnection operation is converted into register operations and memory data movement operations of heterogeneous accelerators, achieving the conversion of high-speed interconnection operations to traditional high-speed communication methods. The operation context of the remote heterogeneous device is virtualized to the local high-speed interconnection remote virtualization module processor, realizing the mapping of the remote heterogeneous device state to the local environment. The high-speed interconnection remote virtualization module processor can perform related operations locally based on the remote state, that is, the CPU in the local communication device can access the high-speed interconnection remote virtualization module processor in the same way it accesses local heterogeneous accelerators, without relying on software, causing no performance damage to the communication device, reducing communication latency and the computational resource occupation of the communication device, ensuring communication performance and local application business operation performance.

Based on the above embodiments, the high-speed communication apparatus also includes:
an establishment module, configured to establish a connection between the high-speed interconnection remote virtualization processor and the target remote heterogeneous device through a high-speed communication link after the target heterogeneous device is started.

Based on the above embodiments, the high-speed communication apparatus also includes:
an allocation module, configured to allocate context information corresponding to the target remote heterogeneous device after the target heterogeneous device is started and the connection between the high-speed interconnection remote virtualization processor and the target remote heterogeneous device is established through a high-speed communication link.

Based on the above embodiments, the allocation module includes:
an allocation unit, configured to allocate memory function data and register-related data corresponding to the target remote heterogeneous device.

Based on the above embodiments, in other feasible embodiments, the high-speed communication apparatus also includes:
a connection module, configured to issue the high-speed interconnection operation to the high-speed interconnection remote virtualization processor through the high-speed interconnection module after allocating the context information corresponding to the target remote heterogeneous device.

Based on the above embodiments, the operation conversion module includes:
a conversion unit, configured to convert the high-speed interconnection operation into register operations and memory data movement operations on the heterogeneous accelerator of the target heterogeneous device through the high-speed interconnection operation mapping processing unit and the microcode processing unit.

Based on the above embodiments, in other feasible embodiments, the high-speed communication apparatus also includes:
a configuration information setting module, configured to set corresponding configuration information through the microcode processing unit based on the register information of the target remote heterogeneous device; the configuration information is used for communication adaptation with the target remote heterogeneous device.

Based on the above embodiments, in other feasible embodiments, the high-speed communication apparatus also includes:
a virtualization module, configured to virtualize the operation context of the target remote heterogeneous device to the local high-speed interconnection remote virtualization processor.

Based on the above embodiments, in other feasible embodiments, the high-speed communication apparatus also includes:

A splitting module, configured to split the high-speed interconnection operation instruction into multiple high-performance communication instructions if the high-speed interconnection remote virtualization processor receives the high-speed interconnection operation instruction.

Based on the above embodiments, if the high-speed communication apparatus includes the splitting module, it may also include:
a read processing module, configured to, in response to the high-speed interconnection operation instruction including a read instruction, receive the read instruction and allocate corresponding read request memory; read the memory data on the heterogeneous device according to the read instruction and respond to the read instruction based on the memory data; release the read request memory;
a write processing module, configured to, in response to the high-speed interconnection operation instruction including a write instruction, receive the write instruction and allocate corresponding write request memory; write data to the write request memory and write the data to the memory on the heterogeneous device through a write operation; the high-speed interconnection remote virtualization processor responds to the read request and releases the read request memory;
a cache processing module, configured to, in response to the high-speed interconnection operation instruction including a cache instruction, receive the cache instruction and allocate corresponding cache request memory write cache data to the cache request memory.

The cache data in the cache request memory is written to the memory on the heterogeneous device through the write operation, and the cache status of the heterogeneous device is updated; the cache data is read to the memory on the high-speed interconnection remote virtualization processor through the read operation; the high-speed interconnection remote virtualization processor then releases the cache request memory and synchronizes the virtualized cache status.

Based on the above embodiments, in other feasible embodiments, the high-speed communication apparatus also includes:
a determination module, configured to determine the accessible memory address range of the target remote heterogeneous device based on the context information after the context information corresponding to the target remote heterogeneous device being allocated.

Based on the above embodiments, in other feasible embodiments, the high-speed communication apparatus also includes:
an update module, configured to update the context information on the high-speed interconnection remote virtualization processor based on the device status of the target heterogeneous device.

Based on the above embodiments, in other feasible embodiments, the high-speed communication apparatus also includes:
a transmission module, configured to perform input-output data transmission with the target heterogeneous device using the input-output protocol based on the high-speed interconnection protocol.

Based on the above embodiments, in other feasible embodiments, the high-speed communication apparatus also includes:
an access module, configured to access the CPU's memory using the system memory protocol based on the high-speed interconnection protocol.

Based on the above embodiments, in other feasible embodiments, the high-speed communication apparatus also includes:
a sharing module, configured to achieve memory sharing between the CPU and the graphics card using the system memory protocol based on the high-speed interconnection protocol.

The present application also provides a non-volatile readable storage medium on which a computer program is stored. When the computer program is executed, it can implement the steps provided in the above embodiments. The non-volatile readable storage medium may include: USB drives, mobile hard drives, Read-Only Memory (ROM), Random Access Memory (RAM), magnetic disks, or optical disks, and other media that can store program code.

The present application also provides a communication device. Referring to FIG. 7, FIG. 7 is a structural diagram of a communication device provided by an embodiment of the present application. As shown in FIG. 7, the communication device may include a processor 1410 and a memory 1420.

The processor 1410 may include one or more processing cores, such as a 4-core processor, an 8-core processor, etc. The processor 1410 can be implemented using at least one of DSP (Digital Signal Processing), FPGA (Field-Programmable Gate Array), and PLA (Programmable Logic Array). The processor 1410 may also include a main processor and a coprocessor, where the main processor is used to process data in an awake state, also known as the Central Processing Unit (CPU); the coprocessor is a low-power processor used to process data in a standby state. In some embodiments, the processor 1410 may integrate a GPU (Graphics Processing Unit), which is responsible for rendering and drawing the content to be displayed on the display. In some embodiments, the processor 1410 may also include an AI (Artificial Intelligence) processor, which is used to handle computational operations related to machine learning.

The memory 1420 may include one or more non-volatile readable storage media, which may be non-transitory. The memory 1420 may also include high-speed random access memory and non-volatile memory, such as one or more disk storage devices and flash memory devices. In this embodiment, the memory 1420 is at least used to store the following computer program 1421, where, after the computer program is loaded and executed by the processor 1410, it can implement the relevant steps of the high-speed communication method for heterogeneous devices executed by the communication device side as disclosed in any of the foregoing embodiments. Additionally, the resources stored in the memory 1420 may also include an operating system 1422 and data 1423, etc., and the storage method may be temporary or permanent. The operating system 1422 may include Windows, Linux, Android, etc.

In some embodiments, the communication device may also include a display screen 1430, an input/output interface 1440, a communication interface 1450, a sensor 1460, a power supply 1470, and a communication bus 1480.

Of course, the structure of the communication device shown in FIG. 7 does not constitute a limitation to the communication device in the embodiments of the present application. In practical applications, the communication device may include more or fewer components than those shown in FIG. 7, or combine certain components.

The various embodiments in the specification are described in a progressive manner, with each embodiment focusing on the differences from other embodiments. The same or similar parts between the embodiments can be referred to each other. For the system provided by the embodiments, since it corresponds to the method provided by the embodiments, the description is relatively simple, and the relevant parts can be referred to the method section for details.

This disclosure uses specific examples to explain the principles and implementation methods of the present application. The description of the above embodiments is only used to help understand the method and core ideas of the present application. It should be noted that for those skilled in the art, without departing from the principles of the present application, several improvements and modifications can be made to the present application, and these improvements and modifications also fall within the protection scope of the claims of the present application.

It should also be noted that in this specification, relational terms such as first and second are only used to distinguish one entity or operation from another entity or operation, and do not necessarily require or imply any such actual relationship or order between these entities or operations. Moreover, the terms “include”, “comprise”, or any other variations thereof are intended to cover non-exclusive inclusion, so that a process, method, article, or device that includes a series of elements not only includes those elements but also includes other elements not explicitly listed, or also includes elements inherent to such process, method, article, or device. Without more restrictions, the elements defined by the statement “including a . . . ” do not exclude the existence of additional identical elements in the process, method, article, or device that includes the elements.

1. A high-speed communication method for heterogeneous devices, applied to a communication device comprising a high-speed interconnection remote virtualization processor, the high-speed communication method comprises:
receiving, by the high-speed interconnection remote virtualization processor, a high-speed interconnection operation;
converting, by the high-speed interconnection remote virtualization processor, the high-speed interconnection operation into register operations and memory data movement operations on a heterogeneous accelerator of a target heterogeneous device;
converting, by the high-speed interconnection remote virtualization processor, the register operations and the memory data movement operations into a communication request; and
communicating, by the high-speed interconnection remote virtualization processor, with the target heterogeneous device through the communication request to perform the register operations and the memory data movement operations.

2. The high-speed communication method according to claim 1, wherein before receiving, by the high-speed interconnection remote virtualization processor, the high-speed interconnection operation, the method further comprises:
establishing a connection between the high-speed interconnection remote virtualization processor and the target heterogeneous device through a high-speed communication link in response to the target heterogeneous device being started.

3. The high-speed communication method according to claim 2, wherein after establishing the connection between the high-speed interconnection remote virtualization processor and the target heterogeneous device through the high-speed communication link in response to the target heterogeneous device being started, the method further comprises:
allocating, by the high-speed interconnection remote virtualization processor, context information corresponding to the target heterogeneous device.

4. The high-speed communication method according to claim 3, wherein the allocating, by the high-speed interconnection remote virtualization processor, context information corresponding to the target heterogeneous device comprises:
allocating memory function data and register-related data corresponding to the target heterogeneous device on the high-speed interconnection remote virtualization processor.

5. The high-speed communication method according to claim 3, wherein after the allocating, by the high-speed interconnection remote virtualization processor, context information corresponding to the target heterogeneous device, the method further comprises:
issuing, by a central processor on a host, the high-speed interconnection operation to the high-speed interconnection remote virtualization processor through a high-speed interconnection module.

6. The high-speed communication method according to claim 1, wherein the converting, by the high-speed interconnection remote virtualization processor, the high-speed interconnection operation into register operations and memory data movement operations on the heterogeneous accelerator of the target heterogeneous device, comprises:
converting, by the high-speed interconnection remote virtualization processor, the high-speed interconnection operation into the register operations and the memory data movement operations on the heterogeneous accelerator of the target heterogeneous device using a high-speed interconnection operation mapping processing unit and a microcode processing unit.

7. The high-speed communication method according to claim 6, further comprising:
setting, by the microcode processing unit, corresponding configuration information according to register information of the target heterogeneous device, wherein the configuration information is used for communication adaptation with the target heterogeneous device.

8. The high-speed communication method according to claim 6, further comprising:
virtualizing operation context of the target heterogeneous device to the high-speed interconnection remote virtualization processor located locally.

9. The high-speed communication method according to claim 1, wherein after receiving, by the high-speed interconnection remote virtualization processor, the high-speed interconnection operation instruction, the method further comprises:
splitting, by the high-speed interconnection remote virtualization processor, the high-speed interconnection operation instruction into multiple high-performance communication instructions.

10. The high-speed communication method according to claim 9, wherein when the high-speed interconnection operation instruction comprises a read instruction, a write instruction, and a cache instruction, after splitting, by the high-speed interconnection remote virtualization processor, the high-speed interconnection operation instruction into multiple high-performance communication instructions, the method further comprises:
in response to determining that the high-speed interconnection operation instruction comprises the read instruction, receiving the read instruction and allocating a corresponding read request memory for the read instruction; reading memory data on the heterogeneous device according to the read instruction and responding to the read instruction based on the memory data; releasing the read request memory;
in response to determining that the high-speed interconnection operation instruction comprises the write instruction, receiving the write instruction and allocating a corresponding write request memory; writing data into the write request memory, and writing the data into the memory of the heterogeneous device through a write operation; responding to the read request and releasing the read request memory by the high-speed interconnection remote virtualization processor;
in response to determining that the high-speed interconnection operation instruction comprises the cache instruction, receiving the cache instruction and allocating a corresponding cache request memory; writing cache data into the cache request memory; writing the cache data in the cache request memory into the memory of the heterogeneous device through a write operation, and updating the cache status of the heterogeneous device; reading the cache data into the memory of the high-speed interconnection remote virtualization processor through a read operation; releasing, by the high-speed interconnection remote virtualization processor, the cache request memory and synchronizing the virtualized cache status.

11. The high-speed communication method according to claim 3, wherein after allocating, by the high-speed interconnection remote virtualization processor, context information corresponding to the target heterogeneous device, the method further comprises:
determining an accessible memory address range of the target heterogeneous device based on the context information.

12. The high-speed communication method according to claim 3, further comprising:
updating, by the high-speed interconnection remote virtualization processor, the context information on the high-speed interconnection remote virtualization processor based on device status of the target heterogeneous device.

13. The high-speed communication method according to claim 1, further comprising:
performing, by the high-speed interconnection remote virtualization processor, input/output data transmission with the target heterogeneous device using an input/output protocol based on high-speed interconnection protocols.

14. The high-speed communication method according to claim 1, further comprising:
accessing, by the high-speed interconnection remote virtualization processor, a memory of a central processor using a system memory protocol based on high-speed interconnection protocols.

15. The high-speed communication method according to claim 1, further comprising:
sharing, by the high-speed interconnection remote virtualization processor, a central processor's memory and graphics card's memory using a system memory protocol based on high-speed interconnection protocols.

16. A heterogeneous communication system, comprising:
a host, a switch with high-speed communication capabilities, and at least one heterogeneous device connected in sequence;
wherein the host comprises a central processor, a high-speed interconnection module, and a high-speed interconnection remote virtualization module;
wherein the host is configured to perform the following operations through the high-speed interconnection remote virtualization processor located on the host:
converting a high-speed interconnection operation into register operations and memory data movement operations on a heterogeneous accelerator of the heterogeneous device; converting the register operations and the memory data movement operations into a communication request; communicating with the heterogeneous device through the communication request to perform the register operations and the memory data movement operations.

17. The heterogeneous communication system according to claim 16, wherein the high-speed interconnection remote virtualization processor is further configured to:
set corresponding configuration information based on register information of a target heterogeneous device, wherein the configuration information is used for communication adaptation with the target heterogeneous device.

18. The heterogeneous communication system according to claim 16, wherein the high-speed interconnection remote virtualization processor is further configured to:
allocate context information corresponding to the target heterogeneous device; and
update the context information on the high-speed interconnection remote virtualization processor based on device status of the target heterogeneous device.

19-20. (canceled)

21. A non-transitory computer-readable storage medium storing a computer program that, when executed by a processor, implements steps of the high-speed communication method for heterogeneous devices according to claim 1.

22. A communication device, comprising a memory and a processor, wherein the memory is stored with a computer program that, when called by the processor, implements steps of the high-speed communication method for heterogeneous devices according to claim 1.
